(19) United States
(12) Patent Application Publication
(10) Pub. No.: US 2022/0048681 A1
(43) Pub. Date: Feb. 17, 2022

(54) TETHERED PLASTIC STOPPER

(71) Applicant: NOVEMBAL USA INC., Edison, NJ (US)

(72) Inventors: Henri GRABARCZYK, Gleizé (FR); Stéphane GRAUX, Liergues (FR)

(21) Appl. No.: 17/279,068

(22) PCT Filed: Sep. 23, 2019
(86) PCT No.: PCT/US2019/052508

§ 371 Date: Mar. 23, 2021

Related U.S. Application Data
(60) Provisional application No. 62/735,185, filed on Sep. 23, 2018.

(51) Int. Cl. B65D 41/34; B65D 43/16; B65D 55/16

(52) U.S. Cl. CPC B65D 41/3428; B65D 2251/10; B65D 55/16; B65D 43/16

(57) ABSTRACT

The present invention includes a tethered plastic stopper having a tamper band, a closure shell having a plurality of tongues, and a hinge attached at a bottom portion to the tamper band and attached at a top portion to the closure shell. The closure shell is separably connected to the tamper band through a weakness line. The plurality of tongues each extend outwardly relative to the periphery of the stopper and being positioned around a periphery of the stopper.

### TECHNICAL FIELD

This present disclosure relates generally to closures for containers. More specifically, the present disclosure relates to a tethered closure secured to a bottle neck.

### BACKGROUND

In the field of liquid packaging, it is very common to seal the aperture of a container with a stopper, often made from a plastic material. Such a container is usually a plastic bottle, but other materials may be used as well.

The stopper has a tubular shape closed at its top edge by a top wall. The stopper comprises a roof attached to a tamper shell through bridges. Bridges are distributed around the circumference of the roof and the tamper shall. The bridges may be made when molding the stopper or after through undergoing a cutting step during the manufacturing process.

Usually the bottle neck includes outer fixation feature, such as thread(s) for screw type stopper or annular fixation rings for snap type stopper, to secure the stopper on the bottle neck.

For screw type stoppers, the tamper shell comprises inner thread(s) arranged inside side walls. The bottle neck fixation feature may include outer thread(s). Such combination of outer and inner thread(s) allows the stopper to be screwed on a bottle neck to seal it and unscrewed for bottle opening. A snap type stopper may include an inner annular area and the bottle neck fixation feature may include outer fixation ring, in order to slot in force the stopper on the bottle neck. A snap type stopper may include a tamper shell with a movable sealing roof from a closed position to a partial opening position, and reversely. The roof may be separated upon opening or may be connected to the tamper shell.

In a bottle sealing position of the stopper, the tamper shell may be secured around the bottle neck through inner shell retaining features or through the retaining features diameter being smaller than a diameter of a tamper shell of the bottle neck.

The roof may be removable. During bottle opening, the bridges form a weakness line and may be torn apart from the roof, separating it from the bottle. The weakness line may be torn when user unscrews the tamper shell of the stopper or when user lifts the roof by tilting.

There is a recycling risk with separable roof as consumers may not always screw or snap back the roof onto the bottle neck once empty. The stopper may be thrown away as litter or put into the trash bin, or worse make its way into a landfill, which is not good in view of the environmental considerations.

One solution includes linking the roof to the tamper shell secured on the bottle neck, so the roof stays attached to the bottle after bottle opening. Such an attached stopper may be called a “tethered stopper.”

Other known art prior art systems include a tethered stopper comprising a spiral strip. The spiral strip is made during the stopper molding so there is no cutting or slitting operations. Other known prior art systems includes tethered stoppers comprising two strips linking the closure shell to the tamper band secured on the bottle.

### SUMMARY

This invention provides an improved tethered plastic stopper where its closure shell remains attached to its tamper band after bottle opening via a linking feature. The attachment is operated through a hinge which connects the tamper band secured on the bottle neck with the closure shell. Typically, the stopper can be of a snap type.

The peripheral edge of the closure shell comprises outer tongues where the outer tongue outwardly extends relative to the periphery of the closure shell. The tongue(s) help the user push from underneath, from bottom to top, in order to open the closure shell. In addition, the tongues allow the stopper to be fixed on the bottle neck when sealing the bottle.

In an alternative embodiment, a blocking tongue situated over the hinge, can allow the closure shell to be secured in an opened position. Therefore, a blocking tongue can cooperate with a hole created into the tamper band positioned under the hinge.

### DESCRIPTION OF DRAWINGS

The components in the figures are not necessarily to scale, emphasis being placed instead upon illustrating the principles of the invention. In the figures, like reference numerals designate corresponding parts throughout the different views.

FIG. 1 is a diagrammatic perspective view of an embodiment of a tethered stopper secured on a bottle neck when the bottle is in a closed position.

FIG. 2 is a diagrammatic lateral view of an embodiment of the tethered stopper secured on a bottle neck when the bottle is in a closed position.

FIG. 3 is a diagrammatic top view of an embodiment of the tethered stopper.

FIG. 4 is a diagrammatic section view of a detail of an embodiment of the tethered stopper secured on a bottle neck when the bottle is in a closed position.

FIG. 5 is a diagrammatic section view of a detail of the embodiment shown in FIG. 4 where the tethered stopper is secured on a bottle neck in an opened secured position.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

Phrasing such as ‘configured to’ perform a function, including in the claims, can include any or all of being sized, shaped, positioned in the arrangement, and comprising material to perform the function.

Terms indicating quantity, such as ‘first’ or ‘second’ are used for exemplary and explanation purposes and are not intended to dictate the specific ordering of a component with respect to other components. Terms indicating position such as ‘upper’ and ‘lower’ or ‘front’ and ‘back’ are used to indicate components relation to one another. One of skill in the art would recognize other configurations are possible.

Various embodiments of the present disclosure are disclosed herein. The described embodiments are merely exemplary illustrations of implementations set for a clear understanding of the principles of the disclosure. Variations, modifications, and combinations may be made to the described embodiments without departing from the scope of the claims. All such variations, modifications, and combinations are included herein by the scope of this disclosure and the claims.

The invention relates to a tethered plastic stopper 100, for closing a bottle neck 400. The stopper 100 generally has a tubular shape. The stopper 100 is integrally made of one plastic piece by a molding fabrication step. Other parts or elements of the stopper 100 can be created into the plastic piece through a cutting or slitting step during the manufacturing process.

The stopper 100 comprises a tamper band 102 and a closure shell 104. The tamper band 102 and the closure shell 104 are linked together, the tamper band 102 being top connected around the bottom of the closure shell 104. At its bottom edge the tamper band 102 comprises retaining features. The retaining features secure the stopper 100 when sealing the bottle neck 400. The retaining features can form a collar. Usually, after the collar is inverted inside the tamper band, in bottle sealing the collar locks the tamper band 102 and the entire stopper 100 against a tamper evident ring 406 positioned outwardly around the bottle neck 400. The retaining features can also be molded directly from the injection process resulting in beads that do not need to be inverted like the collar.

The stopper 100 is a snap type comprising inner fixation features, such as inner annular ring(s) 402, designed to cooperate with outer complementary fixation features made on the bottle neck 400, such as outer annular ring(s) 404 and the tamper evident ring 406.

The stopper 100 comprises at least a weakness line 106 between the closure shell 104 and the tamper band 102. The weakness line 106 is made of bridges 108. The bridges 108 are distributed almost all along the weakness line 106, regularly or not. The bridges 108 link the closure shell 104 to the tamper band 102. Thus, when opening the closure shell 104, the bridges 108 are teared apart from the closure shell 104 and from the tamper band 102. The closure shell 104 can be manually separated by the consumer, in order to access the bottle neck 400.

The closure shell 104 is typically not removable from the rest of the stopper 100, especially from the tamper band 102. The stopper 100 comprises a hinge 110. The hinge 110 is top attached to the closure shell 104 and bottom attached to the tamper band 102. Hence, when opening, the closure shell 104 stays attached to the tamper band 102 through the hinge 110, the tamper band 102 being secured on the bottle neck 400 through its retaining features 106 such as weakness line 106 that extends along all the periphery of the stopper 100, except along the hinge 110. The hinge 110 angularly extends from 5° to 90° relative to the stopper periphery.

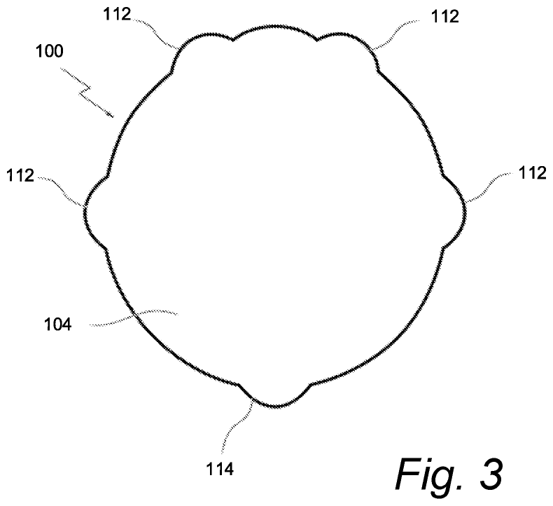

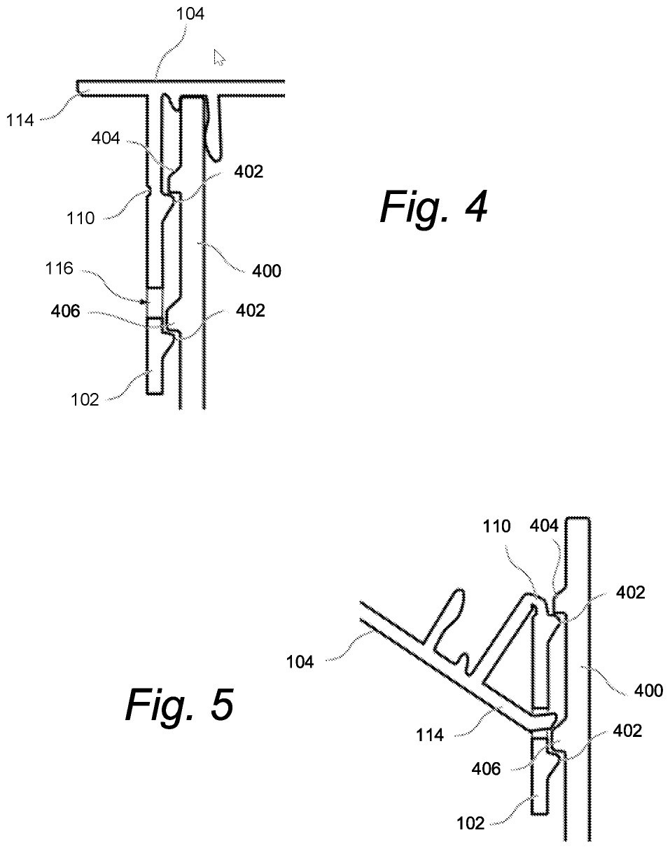

The closure shell 104 comprises tongues 112. The tongues may be positioned outwardly to extend relative to the periphery of the closure shell 104. The tongues 112 are generally flat, laterally extending from the top roof of the closure shell 104. The tongues 112 can have several shapes. As shown in FIG. 3, the tongues 112 generally have a curved shape, which is convex relative to the global circular periphery of the closure shell 104.

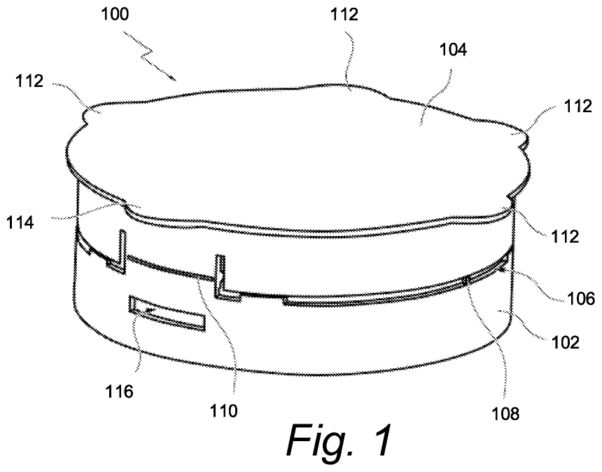

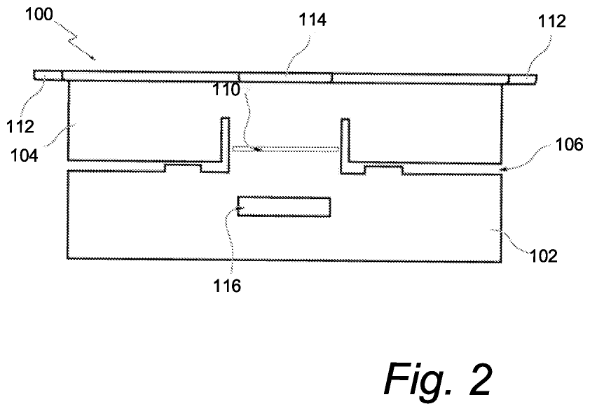

Several tongues 112 are distributed, regularly or not, around the closure shell periphery. For example, the two or more of the tongues 112 are distributed equidistant around the periphery of the closure shell. There are at least three tongues distributed around. As shown in FIGS. 1 and 3, there are five tongues 112 shown. The tongues 112 allow the stopper 100 to be fixed on the bottle neck 400. When sealing the bottle neck 400, the stopper 100 is placed into a gripping device, especially a gripping device with a conic shape. Hence, the tongues 112 secure the stopper 100 into the gripping device.

The tongues 112 also help the consumer for opening the bottle. The consumer can push up from underneath the tongues 112 angularly situated at the opposite side of the hinge 110. In one embodiment, at least one of the tongues 112 allows the closure shell 104 to be secured on the bottle neck 400 in an opened position. A blocking tongue 114 may be situated about the same angular position relative to the hinge 110, thus the blocking tongue 114 outwardly extends over the hinge 110.

A hollow 116 is created into the stopper 100, especially into the tamper band 102. The hollow 116 is situated under the hinge 110. The hollow 116 angularly extends about the same as the blocking tongue 114. The hollow 116 is dimensioned to receive at least a part of the outer edge of the blocking tongue 114. When opening the stopper 100, the closure shell 104 turns around the hinge 110 and the blocking tongue 114 is engaged into the hollow 116, securing the closure shell 104 into the opened position.

The blocking tongue 114 can be inserted into the hollow 116 until the blocking tongue 114 faces against and almost above the tamper evident ring 406. The end of the blocking tongue 114 can be twisted due to the elasticity of the plastic material and its thickness. In this configuration, the closure shell 104 is secured into the opened position, such as shown in FIG. 5.

The stopper 100 according to the invention offers an improvement as a tethered snap type plastic stopper for closing a bottle neck 400, with a closure shell 104 equipped with tongues. The stopper 100, especially the closure shell 104 has an esthetic shape.

While various embodiments of the invention have been described, it will be apparent to those of ordinary skill in the art that many more embodiments and implementations are possible that are within the scope of this invention.

What is claimed is:

1. A tethered plastic stopper, comprising:
a tamper band;
a closure shell separably connected to a tamper band through a weakness line, the closure shell comprising a plurality of tongues each extending outwardly relative to the periphery of the stopper and being positioned around a periphery of the stopper; and
a hinge attached at a bottom portion to the tamper band and attached at a top portion to the closure shell.

2. The tethered plastic stopper according to claim 1, wherein at least two of the plurality of tongues are spaced equidistant around the periphery of the closure shell.

3. The tethered plastic stopper according to claim 1, further including at least three tongues.

4. The tethered plastic stopper according to claim 1, further including at least five tongues.

5. The tethered plastic stopper according to claim 4, wherein at least the of the tongues are spaced equidistant around the periphery of the closure shell.

6. The tethered plastic stopper according to claim 1, further comprising a blocking tongue angularly situated over the hinge having a hollow angularly situated area under the hinge so that the blocking tongue inserts into a hollow area into an opened position of the closure shell.

7. The tethered plastic stopper according to claim 1, wherein the tongues have a curved convex shape.
